(19) United States
(12) Patent Application Publication
(10) Pub. No.: US 2014/0323602 A1
(43) Pub. Date: Oct. 30, 2014

(54) DIRECT PRINTING METHOD WITH A BASE LAYER

(71) Applicants: KRONES AG, Neutraubling (DE); HEIDELBERGER DRUCKMASCHINEN AG, Heidelberg (DE)

(72) Inventors: Johann Weigert, Ubstadt-Weiher (DE); Andreas Sonnauer, Worth (DE); Florian Lauterbach, Neutraubling (DE); Migjen Rrahimi, Wetzikon (CH)

(73) Assignees: KRONES AG, Neutraubling (DE); HEIDELBERGER DRUCKMASCHINEN AG, Heidelberg (DE)

(21) Appl. No.: 14/262,846

(22) Filed: Apr. 28, 2014

(30) Foreign Application Priority Data
Apr. 29, 2013 (DE) 10 2013 207 809.9

(51) Int. Cl. B41M 3/00; C08J 11/04

(52) U.S. Cl. CPC B41M 3/00; C08J 11/04
USPC 521/48; 427/265; 427/569; 427/226; 427/532; 118/500; 118/244; 118/300; 118/428; 118/620; 118/47

(57) ABSTRACT

A method and a device for direct printing onto plastic containers, where an intermediate layer is in a first step using a first device applied onto the container to be printed and the container is in a second step using a second device printed in certain areas, and the intermediate layer enters into a bond with the container and the print layer that is insoluble in aqueous solutions having a pH value between 3 and 10, and is very soluble in aqueous solutions having a pH value in a range less than 3 and/or greater than 10; and a recycling method for a plastic container having an intermediate layer applied.

### CROSS-REFERENCE TO RELATED APPLICATION

The application claims priority of German Application No. 10 2013 207 809.9, filed Apr. 29, 2013. The priority application, DE 10 2013 207 809.9 is hereby incorporated by reference.

### FIELD OF THE DISCLOSURE

The disclosure relates to a direct printing method and a corresponding printing machine for printing onto containers, in particular PET containers and a corresponding recycling method.

### BACKGROUND

Many options for direct printing onto plastic containers are known from prior art. In this, printing color is applied to the walls of containers in at least one layer.

DE 102010044243 A1 beyond that proposes providing the outer layer of the container with an intermediate layer in order to therewith increase the adhesive strength and other properties of the print layer which is applied onto this intermediate layer.

### SUMMARY OF THE DISCLOSURE

It is one aspect of the present disclosure to provide a direct printing method that improves the recycling properties of printed plastic containers, in particular PET containers and further to provide a recycling process for respective containers.

The direct printing method according to the disclosure includes that the intermediate layer applied forms a bond with the container and the print layer which is insoluble in aqueous solutions having a pH value of between 3 and 10, and well soluble in aqueous solutions having a pH value in a range greater than 10. By providing an intermediate layer which is insoluble in a range of pH values between 3 and 10 that is common during normal service life, but is soluble in an aqueous solution having a pH value in a range greater than 10 and/or less than 3, detaching the intermediate layer and the print layer applied thereonto is facilitated during known recycling methods at least partially occurring in a basic environment. If the intermediate layer detaches in this basic solution, it then in an advantageous manner takes along the print layer applied thereonto from the container wall. This achieves the separation of the plastic material from the printing color and the intermediate layer.

In one embodiment, the intermediate layer is applied only in certain areas onto the containers. This firstly allows for saving raw material being used for the intermediate layer, which allows in particular an environmentally friendly and economical production of the printed containers and it is secondly ensured that the print layer also being applied in these certain areas can in the recycling method efficiently be detached from the container.

In one embodiment, the direct printing method is characterized in that the intermediate layer is applied onto the container by using a rolling device or a spraying device or a dipping device or a direct printing device or a plasma coating device or a flame pyrolysis device (for example by application of a SiOₓ layer). Depending on the area on the container to be applied the intermediate layer and the intended properties of the intermediate layer, use of one of these devices or a combination thereof can be advantageous.

In a further embodiment, the material constituting the intermediate layer is an alkali-soluble polymer or it comprises the latter and/or the intermediate layer contains particles of Teflon, the size of which is between 1 μm and 100 μm, preferably between 8 μm and 15 μm. As polymers have a wide range of chemical properties and can in particular be produced in large quantities and can additionally also be used in the food industry for packaging, this group of substances represents a particularly suitable material for forming the intermediate layer. Due to the use of Teflon particles, adhesion and the resistance to aqueous solutions having a pH value between 3 and 10 can be improved.

In one embodiment, the direct printing method is characterized in that the material constituting the intermediate layer is responsive to irradiation with light of a particular wavelength in that it alters at least one of the properties of adhesion strength, color, barrier characteristics, migration characteristic, spreading characteristics, and where the container is irradiated with light of this particular wavelength using a light source being arranged in the direction of transport downstream of the first device and upstream of the second device. By altering certain properties of the intermediate layer, certain properties of the printed container can be achieved. It is known that by irradiation with respective light, some substances change their color behavior or their barrier characteristics and migration characteristics for the penetration by substances such as oxygen or carbon dioxide. If special demands are here posed upon the intermediate layer, then it can be adapted accordingly by irradiation. If a wavelength range is used for this that is non-hazardous to the material of which the container is made, meaning irradiation of the container with light of this wavelength causes no changes in the container, then this is particularly advantageous because in this manner only the properties of the intermediate layer are altered.

In another embodiment, the intermediate layer is applied to the container in such a manner that the resulting roughness of the surface of the container is increased or decreased in certain areas, or that patterns are created in the certain areas. In this manner, certain properties of the finished plastic container, such as a desired reflection of light or specific surface properties can selectively be influenced by the intermediate layer.

In a further embodiment, the melting temperature of the material constituting the intermediate layer is 70° C. or higher, and/or the surface energy of the plastic container coated with the intermediate layer is between 30 mN/m and 60 mN/m, preferably between 38 mN/m and 46 mN/m. A strength of the intermediate layer and thereby of the print is therewith ensured even at temperatures that are high compared to everyday use, however, the provision of an intermediate layer with a melting temperature being around 70° or slightly higher also enables efficient removal of the intermediate layer during the recycling process. Adjusting the surface energy of the intermediate layer can improve the absorption capacity of inks.

In one embodiment, the direct printing method is characterized in that the intermediate layer is insoluble in aqueous surfactant solutions as well as in ethanol and isopropanol. It is thereby achieved that the printed containers, for example, can also be washed, or when used in specific fields, for example in the laboratory, can also be cleaned accordingly.

Furthermore, the direct printing method can be characterized in that the viscosity of a substance mixture constituting the intermediate layer lies between 2 mPas and 600 mPas.

A direct printing machine can be provided which is suitable for printing onto containers such as bottles, where the direct printing machine comprises a transport device for conveying the containers through the printing machine along a direction of transport, a first device for applying an intermediate layer, and a second device for printing a print layer onto certain areas of the containers, where the direct printing machine provides that it can perform a direct printing method according to the above-described embodiments. Respective printing machines can be configured as linear machines as well as rotary machines.

In one embodiment, the direct printing machine includes that the first device comprises a rolling device or a spraying device or a dipping device or a direct printing device or a plasma coating device or a flame pyrolysis device that can apply the intermediate layer. Certain conditions to be fulfilled by the intermediate layer and/or demanded for the manufacturing process can thereby be met already when applying the intermediate layer.

In a further embodiment, the material constituting the intermediate layer is an alkali-soluble polymer or it comprises the latter and/or the intermediate layer contains particles of Teflon, the size of which is between 1 μm and 100 μm, preferably between 8 μm and 15 μm. Since this material can be produced in large quantities and polymers can be selectively manipulated to exhibit certain properties, the use of this material in the direct printing machine is advantageous. Teflon particles increase adhesion of the intermediate layer to the container and can improve the resistance to aqueous solutions having pH values between 3 and 10.

In another embodiment, the direct printing machine includes a light source in the direction of transport downstream of the first device and upstream of the second device, where the light source can emit light in a particular wavelength range and where the material constituting the intermediate layer is responsive to the irradiation with light in this particular wavelength range. Certain chemical properties and physical properties such as roughness, color or reflection behavior can thereby be manipulated by specific energy input onto the intermediate layer. If a wavelength range is used for this that is non-hazardous to the material of which the container is made, meaning irradiation of the container with light of this wavelength causes no changes in the container, then this is particularly advantageous because in this manner only the properties of the intermediate layer are changed.

A method is also provided for recycling plastic containers, in particular PET containers having an intermediate layer that is bonded to the plastic container and a print layer, where the intermediate layer is insoluble in aqueous solutions having a pH value between 3 and 10 and well soluble in aqueous solutions having a pH value in a range greater than 10, where the recycling method includes that the plastic container is comminuted and detachment of the plastic layer from the comminuted plastic container occurs by nucleophilic substitution. Most residue-free detachment of the intermediate layer and the print layer bonded thereto is thereby achieved.

In one embodiment, detachment of the plastic layer occurs in a recycling solution having a pH value greater than 10, where the recycling solution contains NaOH.

### BRIEF DESCRIPTION OF THE FIGURES

FIG. 1: shows a schematic representation of a direct printing machine according to the disclosure

FIG. 2: shows a schematic representation of the process run when applying the intermediate layer and the print layer

FIG. 3a: shows a schematic representation of the chemical bonding of the intermediate layer and the surface of the PET container according to one embodiment

FIG. 3b: shows a schematic representation of the detachment of the intermediate layer and the surface of the PET container as part of the recycling process

FIG. 4a: shows a microscopic perspective of the generally smooth surface of the container wall

FIG. 4b: shows a microscopic uneven perspective of a generally uneven surface of the container wall

FIG. 4c: shows a container surface similar to that of FIG. 4b, but where the intermediate layer, is selectively applied to even out unevenness and to provide the flattest possible surface for the application of the print layer

FIG. 4d: shows application of the intermediate layer having special properties to create regular surface structures

FIG. 4e: shows a structure that is comparable with the embodiment of the intermediate layer shown in FIG. 4d, but where an intermediate layer is applied such that smaller capillaries form

FIG. 4f: shows a further embodiment of an intermediate layer is altered either entirely or in a certain area by the use of radiation

### DETAILED DESCRIPTION

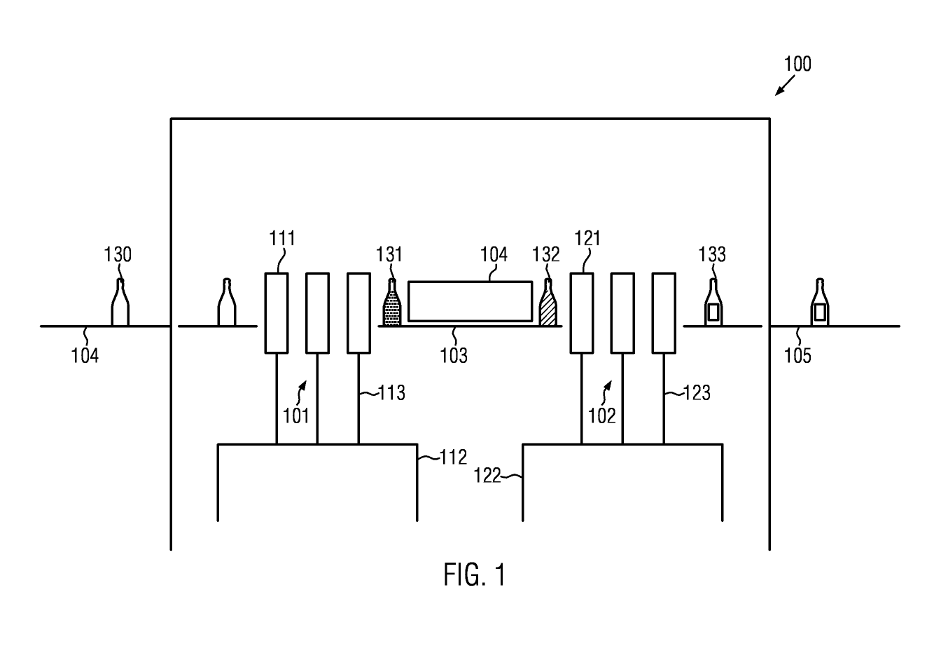

FIG. 1 shows a direct printing machine 100 according to the disclosure for printing onto containers, in particular plastic containers such as PET containers and PET bottles. This direct printing machine 100 comprises a feed conveyor 104 that can supply non-printed bottles or containers 130 to the direct printing machine 100. This can be a linear conveyor or a star conveyor. A first device 101 and a second device 102 are provided in the region of the machine which is presently marked by the rectangle (this presently serves more to illustrate a separation of the direct printing machine 100 and does not need to be manifested in the form of actual components, such as a panel). The first device 101 is adapted to apply an intermediate layer onto the containers 120. Special print heads or print devices 111 are provided for this. They can, for example, be devices that can apply an intermediate layer onto the containers 130 according to the ink-jet method. They can in particular be rolling devices or spraying devices. But also dipping devices, or a direct printing device well-known from prior art, or a plasma coating device or a flame pyrolysis device can be used. If a plasma coating device is used, then it is provided that the first device 101 preferably comprises a vacuum chamber into which the containers 130 can be introduced and in which a respective plasma can be created which creates the coating of the container 130. Alternatively, atmospheric plasma can also be used. In addition to a supply gas employed for this, for example, oxygen, air, nitrogen or carbon dioxide, precursors can be used, such as amide, amine, imide, and silane. These materials or substances can also be employed in pyrolytic methods, such as flame pyrolysis. Furthermore, the first device 101 can in addition to the print modules 111 comprise devices that ensure the application of the intermediate layer only onto certain areas of the container 130. Either respective printing devices can be used for this, such as are known from prior art for printing onto containers, only in selected areas of the containers, or special covering devices for the areas of the containers 130 which are not to be printed on. If devices are used which are already known from prior art, then they must be suited to not only be able to perform the respective printing method for the intermediate layer, but to ensure forwarding and distribution of the material constituting the intermediate layer. In particular devices and lines are suited for this which can convey polymer mixtures contained in solution without sacrificing performance.

Furthermore, the first device 101 comprises a storage container 112, in which the material constituting the intermediate layer is stored. The one or the plurality of modules 111 are connected via lines 113 to the storage container 112. If the intermediate layer is composed of several constituents being applied simultaneously or if it is intends that more than one intermediate layer be applied, where each intermediate layer, for example, can exhibit special chemical and physical properties, then the storage container 112 is configured preferably either as a plurality of separate storage containers or divided into respective chambers, so that the materials which can be used for the different layers of the intermediate layer are not mixed.

The containers 131 provided with the intermediate layer are then passed on via a conveyor 103. Downstream of the first device 101, a radiation unit 104 can presently be provided that can irradiate containers 131 provided with the intermediate layer. The radiation unit 104 can also be configured as a drying unit, and in particular be a heat radiation source that allows selective drying of the intermediate layer or reduction of the water or solvent content of the intermediate layer. The base layer can thereby be prepared for overprinting. By irradiation, preferably with light of a particular selected wavelength, the intermediate layer on the container 131 provided therewith can be selectively altered in terms of its chemical or physical properties. For example, the roughness of the intermediate layer or its surface energy can be altered, so that better adhesion of the print layer applied in the subsequent second device 102 is achieved. A respective radiation device can also be disposed upstream of the first device 101 to activate the surface of the uncoated container 130, so that, for example, better adhesion of the intermediate layer being applied in the first device 101 is achieved.

After exiting the radiation unit 104 or after exiting the first device 101, respectively, if no additional irradiation is intended, the containers 132 being (irradiated and) provided with the intermediate layer are forwarded to the second device 102. This device can be a printing or direct printing machine known from prior art that applies a print layer onto the container 132 using print modules 121. For this purpose, the second device 102 preferably comprises a plurality of print modules 121, though only one print module 121 can also be provided. A storage container 122 can also be associated with the second device 102 and connected via respective supply lines 123 with the print modules 121. If different colors are used for printing or different materials, then this storage container can be designed similarly to storage container 112. After printing of the print layer in the second device 102 is completed, the printed container 133 can be forwarded via another conveyor 105. Additionally process steps can there follow, in particular further irradiation of the printed container 133. The first device 101 and second device 102 can be configured similarly to common printing machines as rotary machines, and not, as presently shown, as linear printing machines.

Regardless of the specific embodiments of the printing machine or direct printing machine 100 described herein, it is to be mentioned that it can in principle be designed as a linear machine or a rotary machine.

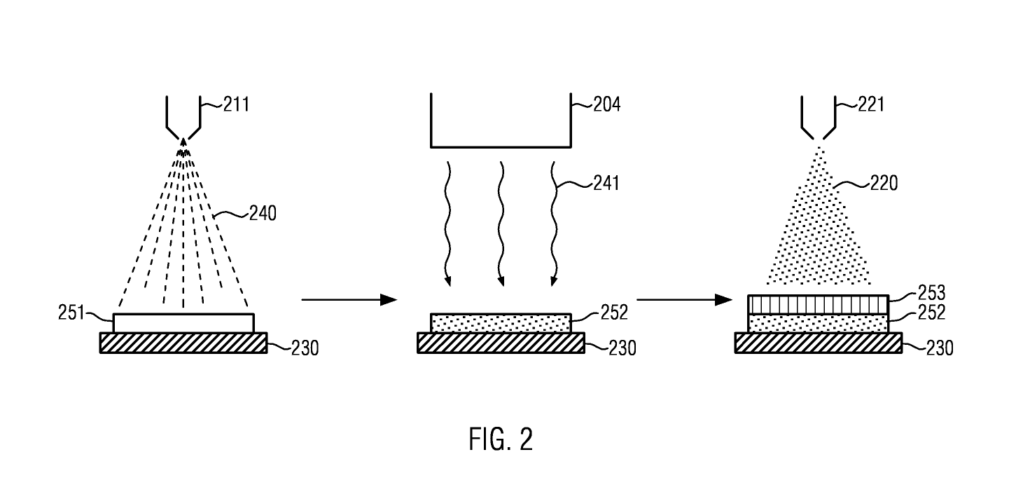

FIG. 2 shows a simplified representation of an application method.

In a first step, the intermediate layer 251 is applied onto the container 230. This can in a particularly preferred embodiment be performed using an ink-jet method in which only areas are applied the intermediate layer 251 that are later to be covered with a print layer. For this purpose, the intermediate layer 251 is applied with at least one of the respective modules 211 that are described in greater detail in FIG. 1, for example, using a drop-on-demand method. It should be noted that the surface energy of the container thus coated can be influenced by the application of the intermediate layer 251. An intermediate layer 251 can be applied in such a manner that the surface energy lies between 30 mN/m and 60 mN/m. More preferably, the surface energy lies between 38 mN/m and 46 mN/m. Since the surface energy of the coated plastic container 230 has influence on the distribution of printing colors or ink applied, this allows for selectively influencing the distribution of the inks applied onto the intermediate layer 251. Depending on the surface energy of the coated plastic container and the interfacial energy between ink to be applied and the coated plastic container 230, as well as the surface tension of, for example, a droplet of ink, it can thereby exactly be established whether the ink spreads over a large area on the surface of the plastic container 230 coated with the intermediate layer 251 or whether there is a concentration of ink droplets at on point.

After the intermediate layer 251 has been applied to the container, irradiation with the aid of a radiation unit 204 can optionally occur. It preferably emits wave light in a specific wavelength range or of a specific wavelength 241 and therewith irradiates the container 230 and in particular the intermediate layer 252. Depending on the wavelength of the light 241 and the material constituting the intermediate layer 252, the entire intermediate layer or certain constituents of this intermediate layer can be chemically and physically altered. The intermediate layer can in particular be activated, whereby the surface energy is increased, for example, facilitating the subsequent application of the print layer or improving bonding between the print layer and the intermediate layer. It is also conceivable to selectively activate constituents in the intermediate layer 252 with the aid of the irradiation, so that there is, for example, a change of color.

In a further method step, the container 230 having the intermediate layer 252 disposed thereon is provided with a print layer 253. Preferably an ink-jet method is also used for this, where any other suitable printing method can be used that is employed in particular in the packaging industry for applying color or the respective color mixture from one of the print modules 221 onto the intermediate layer 252.

It should presently be mentioned that both the intermediate layer 252 as well as the print layer 253 can be composed of several layers. In can also be provided during the first method step, shown in FIG. 2 in which the intermediate layer 251 is applied to the container surface 230, that a plurality of modules 211 are arranged in sequence and each of the modules applies different materials onto the container wall 230. They can be provided on top of each other, i.e. in the form of a multilayer intermediate layer 251. However, it can also provided that different materials for different intermediate layers are disposed in only certain areas of the container wall 230. It can be provided, for example, that an intermediate layer 251 is applied in the areas on the container wall 230 in which the print layer 253 will be applied in the subsequent step. Furthermore, it can be provided that an intermediate layer is also applied onto the container wall 230 in other areas in which the print layer 253 is not applied. It can in its properties differ from the intermediate layer 251 first applied. For example, it can be provided for this intermediate layer that it influences in particular migration characteristics of additionally employed substances or the barrier characteristics against the ingress or egress of CO₂ and oxygen. It can also further be provided that all intermediate layers used comprise a set of same properties, but differ with respect to other properties (for example, reflection behavior, color, roughness and strength). It can be provided that, either in the multi-layered intermediate layer or in the plurality of intermediate layers used which are applied in different areas, an intermediate layer is included which is configured such that it can be scraped off the container surface, whereas the adhesive strength of the other intermediate layers is especially high.

It is also conceivable to perform a plurality of irradiations with the aid of radiation units 204 and to apply a plurality of print layers 253. It should also be mentioned that it can be an advantageous embodiment of this disclosure to perform the process runs illustrated in FIG. 2 successively multiple times and in a different sequence. For example, irradiation of the uncoated container wall 230 for activation can also occur prior to the application of the intermediate layer 251. In addition, a further intermediate layer 251 can be provided after application of the print layer 253. This can be either provided as a top layer and be highly scratch resistant to prevent, for example, damage to the print or it can have other properties and in particular act as an intermediate layer for further print layers. Various embodiments and process runs are therefore conceivable.

Since the intermediate layer is above all to fulfill the task of improving the recycling properties of the printed PET container in that detachability of the print layer from the container wall 230 during a common recycling method is facilitated, the intermediate layer is preferably composed of an alkali-soluble or alkali-reactive or swelling polymer forming a strong bond with the container wall 230. Respectively suitable polymers are, for example, co-polymersates of methacrylates, methacrylic acids, and other acrylates, and in particular, the polymers polyacrylonitrile, polyacrylate, polyacrylamide. Furthermore, statistical copolymers and block polymers, as well as terpolymers containing acrylic acid or methacrylic acid groups are suitable. In addition, carboxymethyl celluloses or respective derivatives can be used. They are particularly preferred because they are used as a food additive and are therefore nonhazardous also as an intermediate layer on packages and are additionally produced from renewable raw materials and degrade in an environmentally acceptable manner. Furthermore, maleic acid anhydride co-polymers can be used. They have a relatively high melting temperature, in particular allowing applicability of the containers coated therewith in everyday use, whereas removal of an intermediate layer made thereof from the container wall 230 during a recycling process with warm washing water is possible, in particular at melting points above 70° Celsius. It is further preferred that the intermediate layer is detachable in a basic environment and possibly above a certain temperature. In particular at temperatures above 70° C. and a pH value of above 10, the intermediate layer is to be easily detachable from the container wall 230. A polymer well soluble in a basic environment is the BELLAND® polymer. Suitable for the purposes of the disclosure would also be, for example, a hydroprimer. It can also be preferable to use a slightly basic cross-linking coating agent on an acrylate base.

Combinations of the aforementioned substance mixtures and the incorporation of other materials are possible. For example, photonically active constituents can be incorporated into the intermediate layer which can alter the optical properties of the intermediate layer. It is further possible to use hotmelts commonly employed for labeling bottles. This again gives rise to the advantage that they have relatively high melting temperatures (above 60° C.) and, though they can be removed in a standard recycling process, are for everyday use, however, given in solid form. As an example, the hotmelt “Euromelt 325” is mentioned. It is particularly preferable that the intermediate layer, when the container is completely finished, exhibits properties ensuring that the intermediate layer bonds to the container and the print layer, where this bond is insoluble in aqueous solutions having a pH value between 3 and 10.

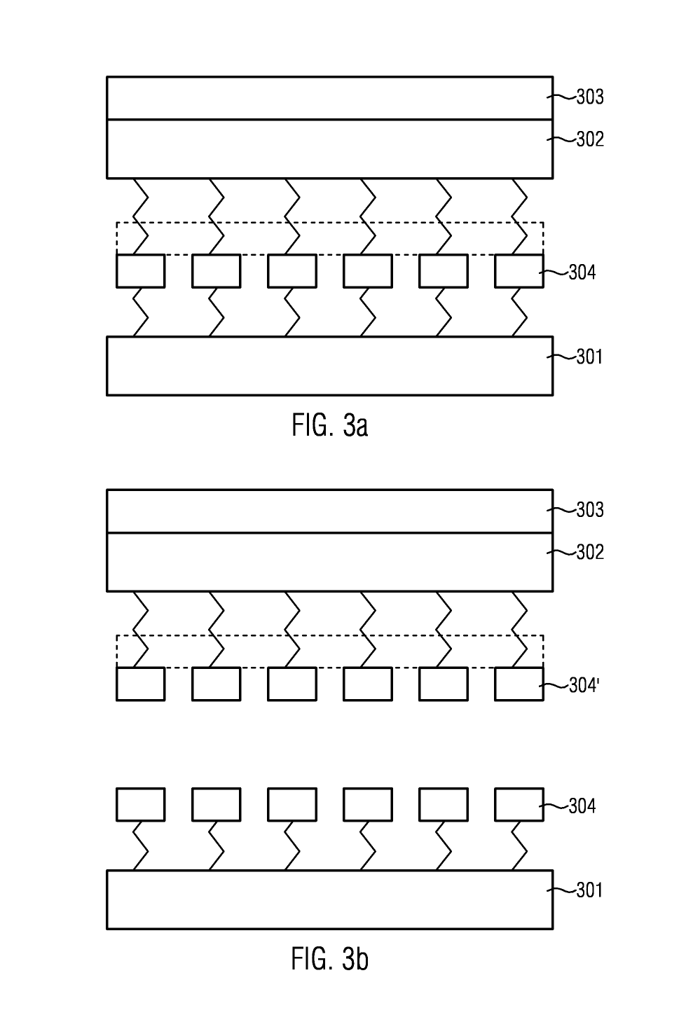

FIG. 3 by way of example shows the chemical principles for this.

In order to ensure adhesion of the intermediate layer 302, firstly, on the container 301 and, secondly, on the print 303, it can be intended to create nucleophilic centers 304 on the surface of the PET container 301 to be coated, for example, by a basic coating solution. In this, firstly, the PET material 301 is split at least in part on the surface of the container by alkaline ester hydrolysis thereby creating carboxylate groups. With the basic coating solution, deprotonation of the unsaturated carboxylic acid groups of the PET material occurs at the surface thereby creating nucleophilic centers 304. In addition, terminal alcohol groups existing on the surface of the PET container 301 can also be used as a nucleophilic center 304. To positively influence the adhesive properties of the intermediate layer 302, further additives can during production be admixed to the PET material. Derivatives of carboxylic acid are particular suited for this, such as carboxylic acid ester, amide, halogenide, chloride, salt, anhydride, hydrazide, azide, dithiocarboxylic acid, thiocarboxylic acid, peroxycarboxylic acid, diacyl peroxide, hydroxamic acid, ketenes, imidocarboxylic acid, imidocarboxylic acid ester, amidines, amidrazones, ortho acid esters or nitriles. When they are added to the PET material during production of the container, they develop nucleophilic centers and can thereby improve bonding to the intermediate layer. In addition, the use of these additives has proven advantageous in the recycling process.

Acrylate derivatives, such as acrolein, crotonaldehyde, acrylonitrile, acrylic acid, methacrylic acid or acrylamide can then be bound, for example, by Michael addition to the nucleophilic centers 304 thus created because simple carbon-carbon bonds can be formed. Other bonds which can presently also be created are C—S, C—O, C—N bonds, for which reason a respective nucleophilic surface of the PET container 301 is suited for a numerous substances that can be used as the intermediate layer 302. Due to the addition, covalent bonds between PET and acrylic acid derivatives are created which can further polymerize with the constituents of the coating solution. The resulting covalently bound acrylate polymers in connection with the nucleophilic centers 304 form the intermediate layer 302 on which, for example, the ink 303 can then be applied. Particularly preferred polymers are presently polyacrylonitrile, polyacrylates, and polyacrylamides. Bondings between the intermediate layer 302 and the surface of the PET container 301 are thereby created as shown in FIG. 3a. The intermediate layer thus formed has in particular the advantage that it is not at all or only with difficulty detachable in common aqueous solutions having pH values between 3 and 10.

To detach this intermediate layer as part of a recycling process from the surface of the PET container 301, nucleophilic substitution can preferably be used. The corresponding process is shown in FIG. 3b. The recycling process usually takes place in a strongly basic solution, such as NaOH. This is in solution given in the form of Na⁺ ions and OH⁻ ions. The hydroxide ion can substitute the nucleophilic centers 304 at the surface of the PET container 301 and form a bond with the intermediate layer 302. It as a nucleophilic portion 304′ substitutes the previous bonding with the nucleophilic centers 304 of the PET container 301. The bond of the intermediate layer 302 and the PET surface 301 is therewith separated and the intermediate layer can be detached from the surface of the PET container 301. The detachment behavior can be further improved by the use of derivatives of carboxylic acid, such as carboxylic acid ester, amide, halogenide, chloride, salt, anhydride, hydrazide, azide, dithiocarboxylic acid, thiocarboxylic acid, peroxycarboxylic acid, diacyl peroxide, hydroxamic acid, ketenes, imidocarboxylic acid, imidocarboxylic acid ester, amidines, amidrazones, ortho acid esters or nitriles when they are added to the PET material as an additive during production of the containers. When the intermediate layer 302 with the ink 303 disposed thereon is detached, it can be separated from the parts of the PET container contained in the basic solution.

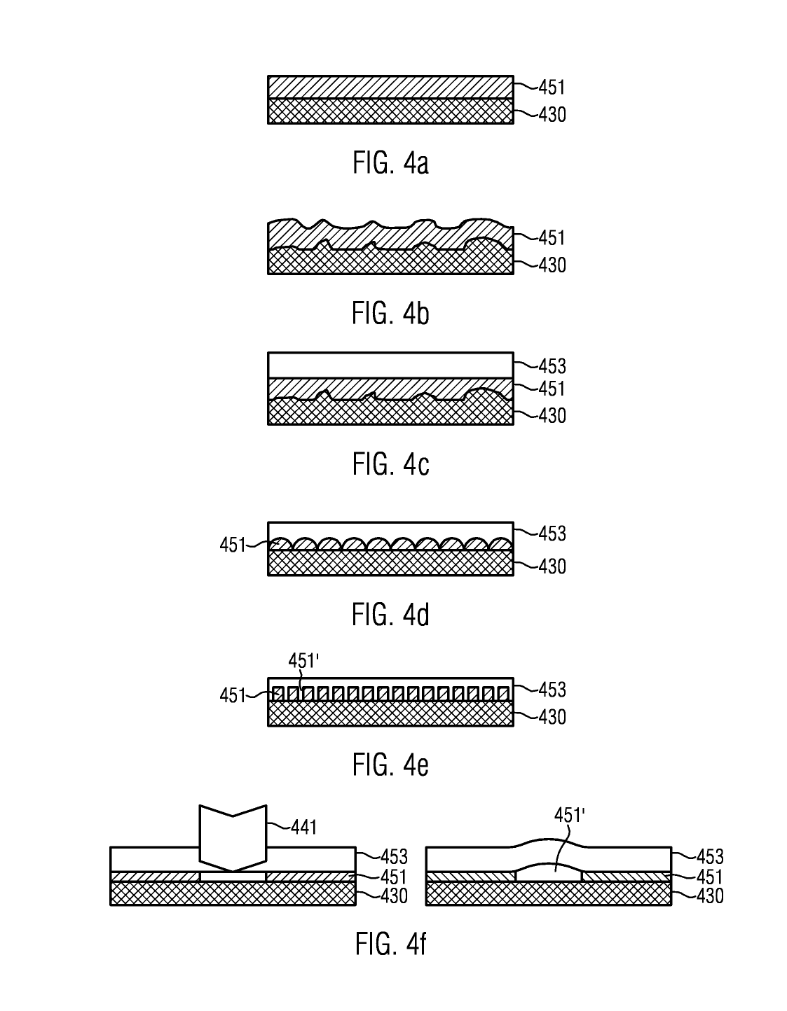

FIG. 4 shows different embodiments of the intermediate layer. FIG. 4a and FIG. 4b show the application of an intermediate layer 451 onto a container wall 430 for differing surface structures of the container wall 430. If the surface of the container wall 430 is as smooth as possible from a microscopic perspective (FIG. 4a), then the intermediate layer 451 can be applied to the surface of the container 430 while preferably being spread evenly. It then mainly serves to separately moderate the adhesion strength of the print layer to the intermediate layer 451 or the adhesion of the intermediate layer 451 to the container surface 430, respectively. This is advantageous especially in cases where the print layer would itself not or only insufficiently adhere to the container surface 330. By the application of a respective intermediate layer between the surface of the container 430 and the print layer, adhesion can thereby be improved.

The same applies to the embodiment shown in FIG. 4b. Here, the surface of the container 330 is microscopically very uneven. It may here be intended to also pass on this unevenness via the intermediate layer. This means therefore that the intermediate layer within the range of certain accuracy reproduces the structure of the surface. This can be advantageous for an intended surface roughness also after printing, for example, to improve slip-resistance of the container.

FIG. 4c shows a container surface 430 with a similar structure as shown in FIG. 4b. The intermediate layer, however, is here selectively applied to even out this unevenness and to provide the flattest possible surface for the application of the print layer 453. For application of the intermediate layer 451, for example, the use of direct printing methods as well as flame pyrolysis methods and all methods leading to uniform distribution on the surface of the intermediate layer 45, regardless of the structure of the substrate (presently the container surface 43), is presently advantageous. With the intermediate layer, all effects described in the previous part of the description can of course also be achieved.

FIG. 4d shows application of an intermediate layer 451 having special properties. This creates regular surface structures and can again be performed using in particular direct printing methods as well as flame pyrolysis methods. This regular structure can significantly improve adhesion of a print layer 453 and can also cause certain visual or haptic properties. With the application of such a regular structure, for example, in the form of a grid, a certain optical effect can be obtained such as light refraction as with rainbows.

FIG. 4e shows a structure that is comparable with the embodiment of the intermediate layer 451 shown in FIG. 4d. Here an intermediate layer 451 was applied such that smaller capillaries 451′ form. With the capillary effect thus obtained, absorptivity of the surface of the container 430 can be increased or supported, respectively. The capillary effect in the capillaries 451 presently selectively causes color absorption of the printing color by the print layer 453. In this context, non-continuous coating is also advantageous. The layer can be selectively discontinued. This can be achieved in particular with pyrolytic methods. In particular, selective discontinuities of the layer can be achieved by selectively printing. Furthermore, statistically distributed discontinuities can also be obtained with other coating methods, for example, when using pyrolytic methods, where treatment can here occur at very short intervals which can lead to the formation of “nuclei” of the coating on the surface of the container that grow from one to the next treatment interval. With these microscopic statistically distributed nuclei and discontinuities in the layer, capillary effects and optical properties can be altered.

FIG. 4f shows a further embodiment of an intermediate layer 451. Here, the intermediate layer is either entirely or, as shown, in a certain area altered by the use of radiation 441. This alteration can not only manifest itself, for example, in optical or physical properties, such as color or roughness, but can also lead to an increased volume. The resulting increased volume 451′ in this selected area provides, for example, for reduction of the adhesion strength of the printed layer 453, whereby, for example, stripping off or rubbing off the printed layer is made possible and haptic properties can additionally be altered.

The additional properties of the intermediate layer described farther above can be achieved in an advantageous manner by using appropriate materials in the intermediate layer. In particular, however, the intermediate layer fulfills the task, firstly, of ensuring and possibly increasing adhesion between the print layer and the container wall, and, secondly, detaching the print layer from the container wall in a recycling process in which, for example, warm water (generally at temperatures from 60°-80° Celsius or higher) or basic solutions (here often with a pH value greater than 10 or in a range above 10) are used. If the intermediate layer is formed from a material having a (considerably) lower density or a considerably higher density than the plastic used for the containers, then it can also be achieved in an advantageous manner that the intermediate layer with the print layer attached thereonto sinks or rises during the recycling process when washing out the comminuted containers in the form of plastic flakes, whereby they can be efficiently separated from the plastic flakes enabling a recycling of the plastic material at a high degree of purity.

It should be mentioned at this point that, though solubility of the intermediate layer or the connection between the intermediate layer and the container wall, respectively, is to be achieved in a basic solution and/or at a given temperature, supporting the detachment process of the intermediate layer, however, is also to be obtained by the mechanical friction of the plastic flakes.

In particular acrylate mixtures with N-ethyl-2-pyrrolidone and/or derivatives thereof are presently mentioned as examples of materials for the intermediate layer. These mixtures exhibit viscosities of around 85 mPas. At a drying time of less than one minute at 50° C., adhesion of 4 is here achieved when using the cross-cut test for adhesion measurement (scale 0-5, where 0 indicates the best possible value). With a washing solution having a pH value of 3 and at 25° C., only partial detachment from the surface of transparent PET material presently occurs. With a strongly basic washing solution, in particular in the presence of NaOH (pH value 13, 2% NaOH and 0.2% surfactant recycling, 25° Celsius), this intermediate layer with the ink disposed thereon detaches.

The mixture just described with the addition of acrylamide and/or respective derivatives on a transparent PET surface is mentioned as another example. These mixtures exhibit a viscosity of 590 mPas. At a drying time of about 1 min under otherwise identical conditions, a characteristic value for adhesion of 1 is obtained. The detachment properties in an acidic and basic environment are similar to the above example.

If this mixture is additionally added Teflon having particle sizes between 8 μm and 15 μm, then a viscosity of 123 mPas results, which can be set by N-ethyl-2-pyrrolidone dosing. Under otherwise identical conditions, and in particular on transparent PET, a characteristic value of 1 for adhesion also arises at a drying time of less than 1 min. Furthermore, the intermediate layer with the ink does not detach in an acidic environment, in a basic environment, however, does so very well.

When being used on white PET under otherwise identical conditions, a value for adhesion (tape test) of 2 or 3, respectively, and 1 is obtained for the same mixtures All 3 mixtures detach from PET containers in a basic environment at 25° C. In an acidic environment, however, detachment is given in part for the first mixture and entirely for the second mixture. The third mixture, however, does not detach from the container.

Recycling a container thus coated is therefore preferably performed in a basic environment. In this, recycling solutions are preferred that in particular have a pH value greater than 10, and there in particular those containing NaOH. For recycling, the plastic containers are first comminuted to ensure effective cleaning and detachment of the intermediate layer with the printing ink. The comminuted pieces of the plastic container (also plastic flakes) are in a further step introduced into the basic recycling solution, whereby the intermediate layer with the printing ink is detached by the recycling solution from the plastic flakes. Detachment there occurs preferably by nucleophilic substitution, as described above. The constituents of the intermediate layer with the printing ink thus separated from the plastic flakes can then, as is common in recycling methods, be removed from the recycling solution, for example, by density differences as compared with the plastic flakes, or remain therein, whereas the plastic flakes are removed from the recycling solution for further processing.

1. A direct printing method for printing onto plastic containers, using a direct printing machine, comprising applying an intermediate layer in a first step using a first device onto a container to be printed, and printing the container in certain areas in a second step using a second device, and the applied intermediate layer enters into a bond with the container and the print layer that is insoluble in aqueous solutions having a pH value between 3 and 10, and is very soluble in aqueous solutions having a pH value in a range less than 3 and/or greater than 10.

2. The direct printing method according to claim 1, and applying the intermediate layer only in certain areas onto the container.

3. The direct printing method according to claim 1, and applying the intermediate layer onto the container by using a rolling device or a spraying device or a dipping device or a direct printing device or a plasma coating device or a flame pyrolysis device.

4. The direct printing method according to claim 1, and the material constituting the intermediate layer is an alkali-soluble polymer or it comprises the latter and/or the intermediate layer contains particles of Teflon, the size of which is between 1 μm and 100 μm.

5. The direct printing method according to claim 1, the material constituting the intermediate layer being responsive to irradiation with light of such a wavelength as to alter at least one of the group of properties of adhesion strength, color, barrier characteristics, migration characteristic, and spreading characteristics, and further comprising irradiating the container with light of the such wavelength using a light source being arranged in the direction of transport downstream of the first device and upstream of the second device.

6. The direct printing method according to claim 1, and applying the intermediate layer to the container in such a manner that the resulting roughness of the surface of the container is increased or decreased in certain areas, or that patterns are created in certain areas.

7. The direct printing method according to claim 1, and the melting temperature of the material constituting the intermediate layer is 70° C. or higher, and/or that the surface energy of the plastic container coated with the intermediate layer is between 30 mN/m and 60 mN/m.

8. The direct printing method according to claim 1, and the intermediate layer is insoluble in aqueous surfactant solutions, in ethanol, and in isopropanol.

9. The direct printing method according to claim 1, and the viscosity of a substance mixture constituting the intermediate layer is between 80 mPas and 600 mPas.

10. A direct printing machine for printing onto plastic containers, comprising a transport device for conveying the containers through the direct printing machine along a direction of transport, a first device for applying an intermediate layer onto the container, and a second device for printing a print layer onto certain areas of the containers, the first device being, in the direction of transport, arranged upstream of the second device.

11. The direct printing machine according to claim 10, and the first device comprises a rolling device or a spraying device or a dipping device or a direct printing device or a plasma coating device or a flame pyrolysis device that can apply the intermediate layer.

12. The direct printing machine according to claim 10, and the material constituting the intermediate layer is an alkali-soluble polymer or comprises the latter and/or the intermediate layer contains particles of Teflon, the size of which is between 1 μm and 100 μm.

13. The direct printing machine according to claim 10, and a light source, in the direction of transport, disposed downstream of the first device and upstream of the second device, and the light source can emit light in a particular wavelength range, the material constituting the intermediate layer being responsive to irradiation with light in the wavelength range.

14. A recycling method for recycling plastic containers having an intermediate layer that is bonded to the plastic container and a print layer, where the intermediate layer is insoluble in aqueous solutions having a pH value between 3 and 10 and very soluble in aqueous solutions having a pH value in a range greater than 10, comprising comminuting the plastic container, and detaching the plastic layer from the comminuted plastic container occurs by nucleophilic substitution.

15. The recycling method according to claim 14, and detachment of the plastic layer occurs in a recycling solution having a pH value greater than 10, where the recycling solution contains NaOH.

16. The direct printing method of claim 1, and the container comprise bottles.

17. The direct printing method of claim 4, and the size of the Teflon particles is between 8 μm and 15 μm.

18. The direct printing method of claim 7, and the surface energy is between 38 mN/m and 46 mN/m.

19. The direct printing machine according to claim 10, and the containers comprise bottles.

20. The direct printing method of claim 12, and the size of the Teflon particles is between 8 μm and 15 μm.
